(19) United States
(12) Patent Application Publication
(10) Pub. No.: US 2021/0055208 A1
(43) Pub. Date: Feb. 25, 2021

(54) TRANSMISSION APPARATUS AND METHOD FOR EXAMINING AT LEAST ONE SAMPLE IN A MICROTITER PLATE BY MEANS OF TRANSMISSION

(71) Applicant: BYONOY GMBH, Hamburg (DE)

(72) Inventors: Yousef NAZIRIZADEH, Frankfurt (DE); Volker BEHRENDS, Kiel (DE)

(73) Assignee: BYONOY GMBH, Hamburg (DE)

(21) Appl. No.: 17/090,966

(22) Filed: Nov. 6, 2020

Related U.S. Application Data
(63) Continuation of application No. PCT/EP2019/060746, filed on Apr. 26, 2019.

(30) Foreign Application Priority Data
May 8, 2018 (DE) 102018111032.4

(51) Int. Cl. G01N 21/25; G01N 21/63; G01N 21/59; B01L 3/00

(52) U.S. Cl. CPC G01N 21/253; G01N 21/255; G01N 21/63; G01N 2201/06; B01L 3/5085; G01N 2201/0407; G01N 21/59

(57) ABSTRACT

A transmission device for examining at least one sample in a microtiter plate, the transmission device including: an illumination device; and a detection device, an intermediate space being formed between the illumination device and the detection device, the intermediate space being configured to receive a microtiter plate. The illumination device including at least one emission source, the illumination device being configured to guide emission light generated by the emission source through the intermediate space. The detection device including at least one detector configured to measure light signals received from the intermediate space; and the detection device includes an angle-dependent filter arranged between the illumination device and the at least one detector in a beam path of the emission light, the angle-dependent filter being configured to substantially only let through light beams having an angle of incidence smaller than a predetermined critical angle.

### CROSS-REFERENCE TO RELATED APPLICATION

The present application is a continuation of PCT/EP2019/060746 filed on Apr. 26, 2019, which is based upon and claims the benefit to DE 10 2018 111 032.4 filed on May 8, 2018, the entire contents of each of which are incorporated herein by reference.

### BACKGROUND

### Field

The present disclosure relates to a transmission device for examining at least one sample in a microtiter plate, comprising an illumination device and a detection device, between which an intermediate space is formed which is configured to receive a microtiter plate, the illumination device comprising at least one emission source and the illumination device being configured to guide emission light generated by the emission source through the intermediate space, the detection device comprising at least one detector, which is configured to measure light signals received from the intermediate space.

The present disclosure also relates to a method for examining at least one sample in a microtiter plate by means of transmission.

### Prior Art

Microtiter plates are commonly used in the fields of medicine, biology and chemistry in order to simplify sample handling. Microtiter plates of this kind comprise a number of wells or cavities in which the samples are arranged. In order to simplify the handling of microtiter plates, the dimensions of the microtiter plates are standardized according to ANSI standard. There are also various formats which have a different number of cavities, for example twelve, forty-eight, ninety-six, three hundred and eighty-four and one thousand five hundred and thirty-six.

An examination method typically used for samples in microtiter plates is transmission examination, in which light is guided through the cavities and the samples contained therein and the light transmitted is measured. In this way, information can be gained about the properties of the samples. A transmission method is commonly used in “enzyme-linked immunosorbent assay” (ELISA) examinations, for example. In ELISA examinations, antigens are detected by absorptively binding the antigens using a primary antibody and an enzyme-linked secondary antibody leads to a reaction of a dye substrate. This reaction of the dye substrate can be detected using ELISA examination.

Apart from measuring the reaction of a dye substrate, fluorescence can also be measured, for example, which arises after irradiation with the light.

Devices by means of which such examinations of samples in microtiter plates are carried out are often large, expensive and difficult to operate. This is due to the fact that these devices often have a mechanism for moving a light emission source and the detector for measuring the transmitted light. A mechanism of this kind can be used to move to all cavities of the microtiter plate one after the other and the transmitted light is measured from the cavities. However, a mechanism of this kind requires additional installation space and incurs additional production costs. Malfunctions in the mechanism also lead to failure of the device.

Furthermore, these devices often have shielding for the measuring space in which the microtiter plate is arranged during measurement. This shielding protects the detector of the device from incident scattered light. However, the disadvantage of this shielding is that it also takes up installation space, and therefore these devices have to have correspondingly large dimensions.

### SUMMARY

An object is to provide a transmission device for examining at least one sample in a microtiter plate and a method for examining at least one sample in a microtiter plate by means of transmission, by means of which device and method said examinations can be carried out in a simple, cost-effective and/or space-saving manner

Such object can be achieved by a transmission device for examining at least one sample in a microtiter plate, comprising an illumination device and a detection device, between which an intermediate space is formed which is configured to receive a microtiter plate, the illumination device comprising at least one emission source and the illumination device being configured to guide emission light generated by the emission source through the intermediate space, the detection device comprising at least one detector, which is configured to measure light signals received from the intermediate space, wherein the detection device comprises an angle-dependent filter, which is arranged between the illumination device and the at least one detector in the beam path of the emission light and which substantially only lets through light beams of which the angles of incidence are smaller than a predetermined critical angle.

The angle of incidence and the critical angle are in each case defined as angles relative to the beam path of the emission light in the intermediate space. Incidence of light beams along said beam path is referred to as perpendicular incidence into the angle-dependent filter. By virtue of the angle-dependent filter, light signals that are substantially perpendicularly incident into the angle-dependent filter can pass through the angle-dependent filter, but obliquely incident scattered light, the angle of incidence of which is greater than the critical angle, can be blocked by the angle-dependent filter and cannot reach the detector. This negates the need for external shielding against scattered light, and therefore the transmission device as a whole is more compact.

In the context of the present patent application, light signals should be understood to mean light beams that reach the detector from the intermediate space. This includes light signals that can be traced back to a reaction between the at least one sample and the emission light, for example on account of the reaction of a dye substrate or due to fluorescence. It also includes light beams of the scattered light that reach the at least one detector and can be detected by the detector.

The critical angle can be set such that, on the one hand, the light signals that can be traced back to a reaction between the at least one sample and the emission light can pass unhindered through the filter and, on the other hand, incident scattered light is blocked substantially completely. The critical angle can be set to a value of between 30° and 1°, such as, to a value of between 10° and 5°.

The at least one detector can be a photodiode that is sensitive to the wavelength range of the emission light or the wavelength of the light signals that can be traced back to a reaction between the at least one sample and the emission light.

The transmitted light can reach the at least one detector exclusively via the angle-dependent filter and, if applicable, a lens. An additional optical waveguide is therefore not required in the detection device, which significantly reduces instrumental outlay.

The angle-dependent filter can be configured as a film. A normal of the film plane can be parallel to the beam path of the emission light in the intermediate space. By designing the angle-dependent filter as a film, a space-saving design for the transmission device can be achieved.

The angle-dependent filter can be a component of the detection device that can close off the intermediate space or define the same at one side.

The angle-dependent filter can be configured as a monitor filter having parallel lamellae. Monitor filters of this kind can comprise a large number of said lamellae, which can have a very small width in the direction of a vertical line on the filter, such that vertically incident light passes through the filter almost unhindered. The height of the lamellae, i.e. the extent of the lamellae in the direction of the vertical line, and the distance between individual lamellae can define a critical angle in the transverse direction of the lamellae. Light beams with an angle of incidence greater than the critical angle are blocked.

The intermediate space can be closed in the longitudinal direction of the lamellae. In this way, when a monitor filter is used, scattered light cannot be incident into the monitor filter in the longitudinal direction of the lamellae.

Alternatively, other types of angle-dependent filters can be used, for example interference filters. Since the critical angle in an interference filter can be wavelength-dependent, the interference filter can be configured such that the critical angle is within a range of between 30° and 1°, such as, between 10° and 1°, in the entire wavelength range of the at least one detector.

The intermediate space can be formed as a rectangular opening in the transmission device, such that the transmission device is configured as an open measuring assembly and the microtiter plate that can be inserted or is located in the intermediate space can be accessed without the need for confirmation of a closure element.

An open measuring assembly should be understood to mean that the intermediate space is provided as an opening and no closure element, for example a closure flap or shutter, is provided for the opening. Configuring the transmission device as an open measuring assembly can provide for a space-saving construction. Since incident scattered light is blocked by the angle-dependent filter, a closure element would be superfluous. Furthermore, on account of the open measuring assembly, a microtiter plate can be inserted and removed at any time, as a result of which quick and simple handling of the transmission device can be achieved.

The intermediate space can substantially match the shape of the microtiter plate that can be inserted or that is located in the intermediate space. In other words, the intermediate space can be configured such that a microtiter plate can be received so as to fit exactly therein, and therefore the dimensions of the transmission device are kept small.

The illumination device can be configured to split the emission light generated by the emission source onto a plurality of partial beam paths, several of the partial beam paths extending as transmission beam paths through the intermediate space to one detector unit of the detection device in each case, each detector unit comprising at least one detector. The transmission beam paths can be parallel to one another in the intermediate space.

By splitting the emission light onto a plurality of partial beam paths, several cavities can be illuminated by a single emission source without the emission source having to be moved. One transmission beam path can be provided for each cavity of a predefinable format of microtiter plates. Depending on the embodiment, the transmission device can be configured to examine microtiter plates having twelve, forty-eight, ninety-six or three hundred and eighty-four cavities. In contrast to a device in which the emission source is moved using a corresponding mechanism, by splitting the emission light onto a plurality of transmission beam paths, a compact and cost-effective design of the transmission device can be implemented.

For each transmission beam path, a transmission examination can be conducted separately using the detector units. The detector units for example can comprise a plurality of photodiodes, which are each sensitive to different wavelength ranges and therefore light signals of various wavelengths can be detected. This produces a compact and, at the same time, flexible transmission device.

At least one of the partial beam paths can be a reference beam path, which is provided for guiding the emission light to a reference detector unit, which is arranged in the illumination device. The reference beam path can be a partial beam path that is formed in addition to the transmission beam paths that extend through the intermediate space. By means of the reference detector, it is possible, for example, to measure the intensity of the emission light, as a result of which aging of the emission source and/or a change in the intensity of the emission light can be identified.

The illumination device can comprise a light mixer, which is configured to homogenize the emission light generated by the emission source and to distribute the emission light with equal intensity onto the partial beam paths, the light mixer can have a rectangular cross-section.

The light mixer can be for example an elongate body having a rectangular cross-section in which the emission light from the emission source is homogenized. As a result, the intensity of the emission light in each partial beam path can be equal and the examination is not corrupted by different intensities.

The partial beam paths in the illumination device can each extend in an optical waveguide, which adjoin the light mixer with their entry sides so as to be bundled together, the optical waveguides in which the transmission beam paths extend can be configured to guide a portion of the emission light from the light mixer to one emission opening of the illumination device in each case, the emission openings can be formed as cut-outs in a holding plate, spherical lenses can be arranged in the emission openings.

The optical waveguides can be flexible cables, for example fiber optic cables or polymer optical fibers. Said optical waveguides can adjoin the light mixer at their entry side so as to be bundled together, such that the emission light can be transmitted to all optical waveguides in an equal manner The exit sides of the optical waveguides of the transmission beam paths can adjoin the emission openings. Said emission openings can be arranged centrally above the cavities, such that the emission light is guided through the optical waveguides and enters the cavities from the emission openings. Spherical lenses can be provided in the emission openings for focusing the emission light.

According to another embodiment, the emission source can comprise at least two, such as at least three, or at least four light-emitting diodes, the emission light from the light-emitting diodes being gathered in the light mixer, an interference filter being arranged between each light-emitting diode and the light mixer, a spherical lens can be arranged in front of and an additional spherical lens can be arranged behind each interference filter, a first light-emitting diode can be configured to emit emission light with a wavelength of 405 nm, a second light-emitting diode can be configured to emit emission light with a wavelength of 450 nm, a third light-emitting diode can be configured to emit emission light with a wavelength of 540 nm and a fourth light-emitting diode can be configured to emit emission light with a wavelength of 630 nm.

The spectra of wavelengths of the emission light from the light-emitting diodes can be limited by the interference filters such that the emission spectra are in each case narrow-band. The emission light can be parallelized by the spherical lenses, which can be arranged between the light-emitting diodes and the interference filters, prior to entering the interference filters. The spherical lenses arranged between the interference filters and the light mixer can couple the light into the light mixer.

By using four light-emitting diodes that can have emission light of different wavelengths, the transmission device can be used to carry out different examinations on the samples in the microtiter plate without an additional transmission device being required or without the light-emitting diodes having to be replaced.

The light-emitting diodes can be arranged horizontally one next to the other. The light mixer can comprise a separate arm for each light-emitting diode, which arms can converge in the direction of propagation of the light. Alternatively, the base surface of the light mixer can have a substantially triangular shape, in this case one side of the triangle can be provided for coupling in the emission light and the two other sides can converge in the direction of propagation of the light.

The transmission device can comprise status lights that are arranged on the outside of the transmission device and light up when the light-emitting diodes are emitting light. A portion of the emission light of each light-emitting diode can be used to illuminate one status light in each case.

Such object can also be solved by a method for examining at least one sample in a microtiter plate by means of transmission, emission light being generated during a first period of time in an illumination device by means of an emission source and the emission light being guided through at least one cavity of the microtiter plate in which the at least one sample is located, light signals received from the at least one cavity being measured by means of at least one detector arranged in a detection device during the first period of time, the method being further developed in that the at least one detector is protected from incident scattered light by means of an angle-dependent filter, the angle-dependent filter being arranged between the illumination device and the at least one detector in the beam path of the emission light and substantially only letting through light beams of which the angle of incidence is smaller than a predetermined critical angle.

The same or similar advantages can apply to the method as were previously mentioned with respect to the transmission device for examining at least one sample in a microtiter plate.

The at least one sample is examined using an open measuring assembly. The microtiter plate can therefore be arranged in an intermediate space that is formed as an opening and that is not closed by a closure element during the examination.

According to an embodiment, the light signals measured during the first period of time can comprise a light measurement, no emission light being guided through the at least one cavity during a second period of time and the light signals measured during the second period of time comprising a dark measurement, the dark measurement being subtracted from the light measurement.

In other words, the light measurement can be carried out during the first period of time and the dark measurement can be carried out during the second period of time. The microtiter plate is arranged in the intermediate space during both the first period of time and the second period of time. Since no emission light is guided through the cavities during the second period of time, the light signals measured during the second period of time correspond to a background caused, for example, by scattered light. By subtracting the dark measurement from the light measurement, the background is thus removed from the measurements and the quality of the examinations is improved. The first period of time and second period of time can be equally long. In this way, the dark measurement can be subtracted from the light measurement without further conversion.

A plurality of measurement cycles can be run through, at least one light measurement and at least one dark measurement being carried out in each measurement cycle and a dark measurement measured in one measurement cycle being subtracted from each light measurement measured in the same measurement cycle.

For example, a measurement cycle can comprise a single light measurement and a single dark measurement, the first period of time and the second period of time can each last 5 ms. This measurement cycle can be repeated several times, the dark signal measured in one measurement cycle being subtracted from the light signal measured in the same measurement cycle in each case. In this way, it is possible to compensate for the influence of changing scattered light conditions, for example flickering room lights, a change in the brightness of the incident daylight, the shadow of a person walking by or the like. The duration of a measurement cycle is as short as possible, such as between 5 ms and 50 ms, such that high-frequency changes in the incidence of scattered light can also be taken into account during measurement.

The emission light can be split up and guided through a plurality of cavities of the microtiter plate at the same time, the light signals of each cavity can be measured in each case by one detector unit comprising at least one detector in each case.

In addition to the advantages described in relation to the transmission device and produced by splitting up the emission light and simultaneously measuring the light signals from all cavities, the light measurements and dark measurements can be measured separately in each case for all cavities. In this way, different intensities of scattered light are taken into account. As a result, it is possible, for example, to compensate for detector units arranged more closely to the opening of the transmission device being exposed to a greater incidence of scattered light. In other words, by virtue of the separate light measurements and dark measurements for each cavity, the different scattered light conditions at the location of the different cavities or detector units are taken into account.

According to an embodiment, the emission light can be generated with at least two, such as at least three, or at least four, different wavelengths by one light-emitting diode of the emission source in each case, the bandwidth of the emission light of each light-emitting diode can be limited by means of one interference filter in each case, such as a first light-emitting diode emitting emission light with a wavelength of 405 nm, a second light-emitting diode emitting emission light with a wavelength of 450 nm, a third light-emitting diode emitting emission light with a wavelength of 540 nm and a fourth light-emitting diode emitting emission light with a wavelength of 630 nm.

The examination of the at least one sample can take place sequentially for each wavelength. For example, a light measurement with a first wavelength can be first measured and then a dark measurement can be carried out. This can be repeated for each wavelength, such that, in the case of four wavelengths, a total of eight measurements together making up a measurement cycle are carried out. It is also possible to carry out the light measurements one after the other with different wavelengths in each case and then carry out a single dark measurement, such that the four light measurements and the dark measurement make up a measurement cycle.

Alternatively, a measurement cycle with the first wavelength and a dark measurement can be initially repeated several times and then the measurement cycles with the other wavelengths and with one dark measurement each can be repeated several times.

Such methods can examine the at least one sample using different wavelengths, the influence of scattered light on the examination being minimized at the same time.

An aging of the emission source and/or a change in the intensity of the emission light from the emission source can be measured by means of a reference measurement, the emission light can be guided along a reference beam path to a reference detector unit, which can be arranged in the illumination device and detects the intensity of the emission light, the intensity of the emission light being compared with previously measured and/or predetermined values for the intensity of the emission light.

A reference measurement of this kind may for example be carried out before and/or after examining the samples in order to monitor the aging of the light-emitting diodes and to check the quality of the examination. In addition to the intensity of the emission light, other properties of the emission light can be measured by means of the reference detector unit, for example whether a mean wavelength of the emission light from a light-emitting diode has changed.

### BRIEF DESCRIPTION OF THE DRAWINGS

Further features will become apparent from the description of embodiments together with the claims and the attached drawings. Embodiments can fulfill individual features or a combination of several features.

The embodiments are described below, without restricting the general idea of the invention, using exemplary embodiments with reference to the drawings, express reference being made to the drawings with regard to all details that are not explained in greater detail in the text. In the following:

FIG. 1 illustrates a diagram of a transmission device for examining at least one sample in a microtiter plate,

FIG. 2 illustrates a diagram of a microtiter plate having ninety-six cavities,

FIG. 3 illustrates a diagram of an illumination device,

FIG. 4 illustrates a diagram showing the internal structure of an illumination device comprising an emission source,

FIG. 5 illustrates the diagram from FIG. 4 with optical waveguides also shown,

FIG. 6 illustrates a diagram of a detection device,

FIG. 7 illustrates an exploded diagram of a detection device,

FIG. 8 illustrates a diagram showing the functioning of a monitor filter.

In the drawings, the same or similar elements and/or parts are provided with the same reference numbers in order to prevent the item from needing to be reintroduced.

### DETAILED DESCRIPTION

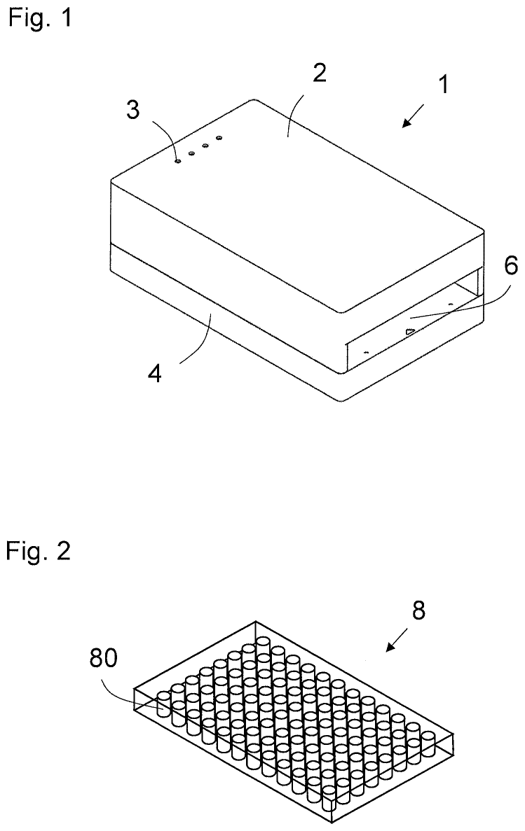

FIG. 1 schematically shows an exemplary embodiment of a transmission device 1. The transmission device 1 comprises an illumination device 2 and a detection device 4, between which there is an intermediate space 6 formed as a rectangular opening. The intermediate space 6 is configured such that a microtiter plate 8 of the like shown in FIG. 2 can be inserted so as to fit exactly therein. The dimensions of the intermediate space 6 therefore substantially correspond to the dimensions of the microtiter plate 8, as a result of which the transmission device 1 has a compact design. Furthermore, the transmission device 1 comprises a plurality of status lights 3. Said status lights 3 are in each case assigned to one light-emitting diode arranged in the illumination device 2. The light-emitting diodes are hidden in FIG. 1. When one of the light-emitting diodes emits light, the assigned status light 3 also lights up. For reasons of clarity, only one of the status lights 3 has been provided with a reference sign.

The microtiter plate 8 shown by way of example in FIG. 2 is of a format having ninety-six cavities 80, and once again only one of these cavities 80 has been provided with a reference sign. The samples to be examined are arranged in these cavities 80 before the microtiter plate 8 is inserted into the intermediate space 6. Since the dimensions of microtiter plates 8 meet an ANSI standard, the intermediate space 6 can be configured to be complementary in shape to these dimensions.

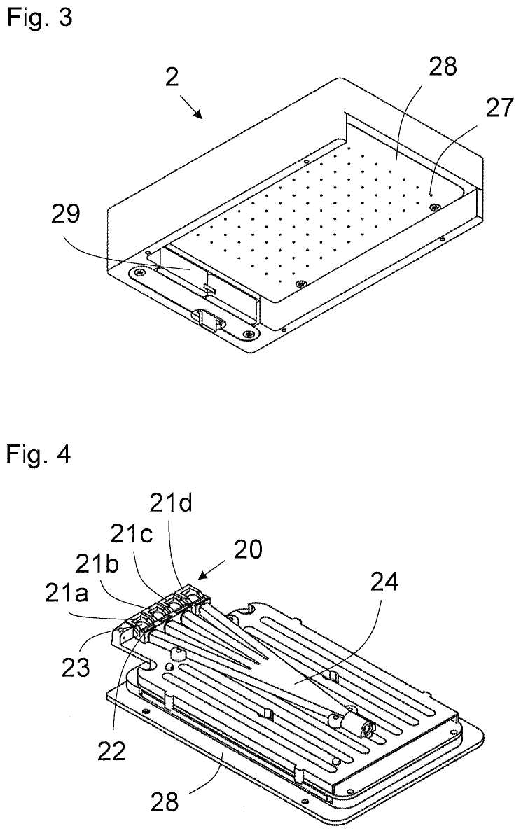

FIG. 3 is a diagram of the illumination device 2, whereby a view obliquely from below has been selected for FIG. 3. The illumination device 2 comprises an ejection device 29, by means of which the microtiter plate 8 can be quickly and simply ejected from the intermediate space 6. A holding plate 28 comprising a number of emission openings 27, of which only one has been provided with a reference sign, is arranged directly above the inserted microtiter plate 8. The number of emission openings 27 corresponds to the number of cavities 80 in the microtiter plate 8. Therefore, in the example shown in FIG. 3, there are ninety-six emission openings 27. The emission openings 27 are arranged such that, when the microtiter plate 8 is inserted, each emission opening 27 is arranged centrally over a cavity 80.

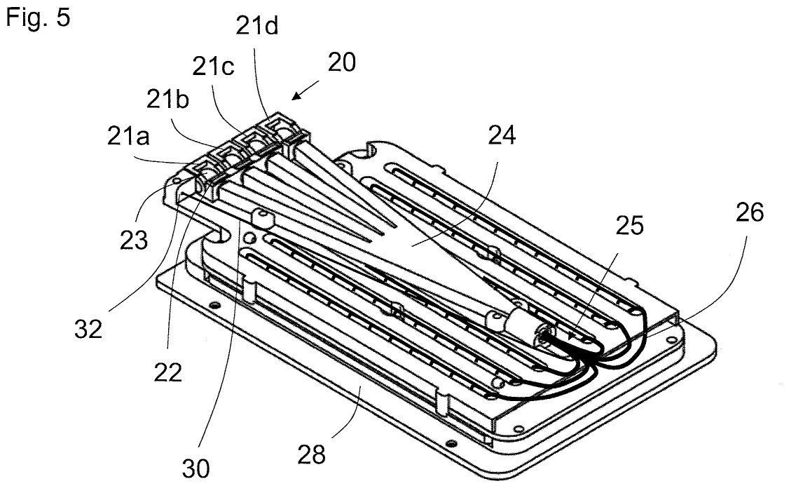

The internal structure of the illumination device 2 is shown in FIGS. 4 and 5. The view selected for FIGS. 4 and 5 corresponds to the view in FIG. 1, and therefore the bottom of the holding plate 28 hidden in FIGS. 4 and 5 corresponds to the bottom of the holding plate 28 shown in FIG. 3. The illumination device 2 comprises an emission source 20, which comprises four light-emitting diodes 21a, 21b, 21c, 21d in the example shown in FIG. 4. By way of example, the emission light of the light-emitting diode 21a has a wavelength of 405 nm, the emission light of the light-emitting diode 21b has a wavelength of 450 nm, the emission light of the light-emitting diode 21c has a wavelength of 540 nm and the emission light of the light-emitting diode 21d has a wavelength of 630 nm. By providing a plurality of light-emitting diodes with different wavelengths, various examinations can be performed using the same transmission device 1. A spherical lens 23 that parallelizes the exiting emission light is in each case arranged directly behind the light-emitting diodes 21a to 21d. For reasons of clarity, again only one of the spherical lenses 23 has been provided with a reference sign. An interference filter 22 that restricts the wavelength spectrum of the emission light from the light-emitting diodes 21a to 21d is arranged behind each spherical lens 23. According to another embodiment not shown in FIG. 4, an additional spherical lens that focuses the emission light is arranged behind each interference filter 22.

A light mixer 24 is arranged behind the interference filters 22 or the additional spherical lenses. Said light mixer 24 homogenizes the incident emission light such that it is distributed with equal intensity in the cross-section of the light mixer 24. For this purpose, according to the embodiment shown in FIG. 4, the light mixer 24 has a rectangular cross-section. If only one individual light-emitting diode 21a is provided, the light mixer 24 for example has the shape of a rod with a rectangular cross-section. However, if a plurality of light-emitting diodes 21a to 21d are provided, as shown in FIG. 4, the light mixer 24 gathers the emission light from the light-emitting diodes 21a to 21d. As shown in FIG. 4, this may for example be done by means of four converging arms. Alternatively, the light mixer 24 may have a substantially triangular base surface, which, when compared with the embodiment shown in FIG. 4, occupies the area between the arms.

FIG. 5 shows the diagram from FIG. 4 enlarged. Partial beam paths 25 are also schematically shown, onto which the emission light of the light-emitting diodes 21a to 21d exiting the optical waveguide 24 is split. For this purpose, a bundle of optical waveguides 26 into which an equal portion of the emission light is coupled in each case is arranged at the exit of the light mixer 24. Said optical waveguides 26 each lead from the exit of the light mixer 24 to an emission opening 27 in which a spherical lens (not shown) for focusing the emission light is arranged in each case. The partial beam paths 25 that extend in the optical waveguides 26 to the emission openings 27 are transmission beam paths. An additional optical waveguide 26, as a reference beam path 30, leads back to a reference detector unit 32, which is arranged next to the light-emitting diodes 21a to 21d. By means of this reference detector unit 32, aging of the light-emitting diodes 21a to 21d and/or a change in the intensity of the emission light can be determined.

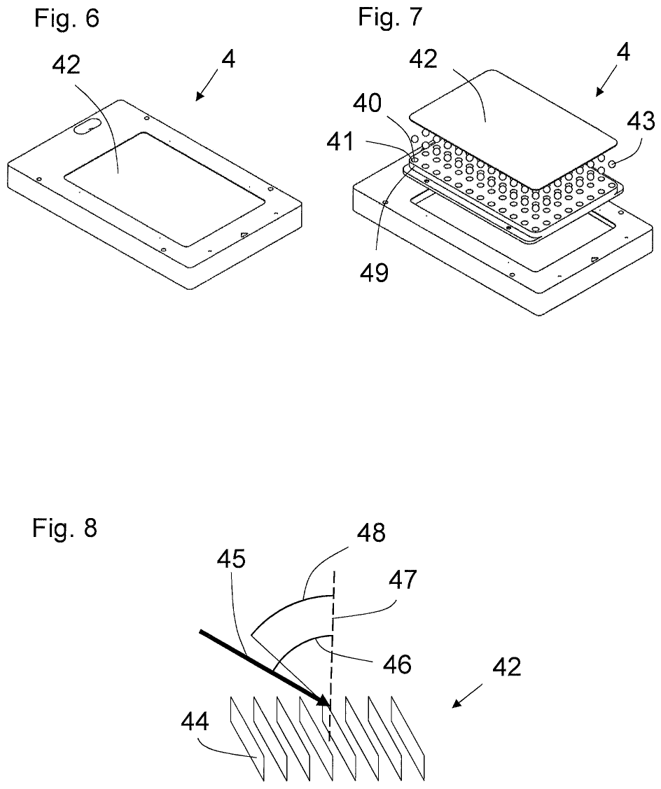

FIG. 6 schematically shows a detection device 4 that is arranged below the illumination device 2 and the inserted microtiter plate 8. In a region of the surface of the detection device 4 that substantially corresponds to the surface area of the inserted microtiter plate 8, the detection device 4 comprises an angle-dependent filter 42 that is configured as a film in the diagram in FIG. 6. Said angle-dependent filter 42 is configured to substantially only let through light beams of which the angle of incidence is smaller than a predetermined critical angle. The critical angle is related to the transmission beam paths of the emission light in the intermediate space 6, which corresponds to a vertical line on the angle-dependent filter 42. In this way, scattered light, which is incident in the intermediate space 6 at an oblique angle, is prevented from passing through the angle-dependent filter 42, and therefore only the light signals from the samples in the intermediate space 6 can pass through.

FIG. 7 shows an exploded diagram of the detection device 4 from FIG. 6. FIG. 7 shows that a detector plate 49 is arranged below the angle-dependent filter 42, which detector plate comprises a series of detector openings 41 arranged centrally below the emission openings 27 and cavities 80 in each case. A detector unit having at least one detector 40 is arranged in each of these detector openings 41. Said detector units are hidden due to the perspective in FIG. 7. The detectors 40 are for example photodiodes that are sensitive to different wavelength ranges. Spherical lenses 43 are in each case arranged in the openings in order to focus the emission light or the light signals onto the detectors 40.

Taking FIGS. 3, 5 and 7 together, it is clear that each of the transmission beam paths extends from the light mixer 24 through an optical waveguide 26, an emission opening 27, the intermediate space 6 or a cavity 80, and the angle-dependent filter 42 to a detector 40 or detector unit. After exiting the emission openings 27, the transmission beam paths extend in parallel with one another.

The functioning of a monitor filter is shown schematically in FIG. 8. A monitor filter of this kind may for example be used as an angle-dependent filter 42. The monitor filter comprises a series of lamellae 44 arranged in parallel with one another. When light is incident along a vertical line 47 in the monitor filter, it can pass unhindered through the monitor filter on account of the small width of the lamellae 44. However, if the angle of incidence 46 of a light beam 45 in the transverse direction of the lamellae is greater than a critical angle 48, the light beam 45 cannot pass through the monitor filter.

In order to prevent the incidence of scattered light, the monitor filter can be arranged in the transmission device 1 such that the transverse direction of the lamellae 44 corresponds to the direction of the opening of the intermediate space 6.

While there has been shown and described what is considered to be preferred embodiments, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE SIGNS

1 Transmission device

2 Illumination device

3 Status light

4 Detection device

6 Intermediate space

8 Microtiter plate

20 Emission source

21a, 21b, 21c, 21d Light-emitting diode

22 Interference filter

23 Spherical lens

24 Light mixer

25 Partial beam paths

26 Optical waveguide

27 Emission opening

28 Holding plate

29 Ejection device

30 Reference beam path

32 Reference detector

40 Detector

41 Detector opening

42 Angle-dependent filter

43 Spherical lens

44 Lamella

45 Light beam

46 Angle of incidence

47 Vertical line

48 Critical angle

49 Detector plate

80 Cavity

What is claimed is:

1. A transmission device for examining at least one sample in a microtiter plate, the transmission device comprising:
an illumination device; and
a detection device, an intermediate space being formed between the illumination device and the detection device, the intermediate space being configured to receive a microtiter plate:
wherein the illumination device comprising at least one emission source, the illumination device being configured to guide emission light generated by the emission source through the intermediate space;
the detection device comprising at least one detector configured to measure light signals received from the intermediate space; and
the detection device comprises an angle-dependent filter arranged between the illumination device and the at least one detector in a beam path of the emission light, the angle-dependent filter being configured to substantially only let through light beams having an angle of incidence smaller than a predetermined critical angle.

2. The transmission device according to claim 1, wherein the angle-dependent filter is configured as a film.

3. The transmission device according to claim 1, wherein the angle-dependent filter is configured as a monitor filter having parallel lamellae.

4. The transmission device according to claim 1, wherein the intermediate space is formed as a rectangular opening in the transmission device such that the transmission device is configured as an open measuring assembly and the microtiter plate inserted in the intermediate space is accessed without the need for confirmation of a closure element.

5. The transmission device according to claim 1, wherein the intermediate space substantially matches a shape of the microtiter plate inserted in the intermediate space.

6. The transmission device according to claim 1, wherein the illumination device is configured to split the emission light generated by the emission source onto a plurality of partial beam paths, each of the plurality of partial beam paths extending as transmission beam paths through the intermediate space to a corresponding detector of the detection device, each detector comprising the at least one detector.

7. The transmission device according to claim 6, wherein at least one of the plurality of partial beam paths is a reference beam path provided for guiding the emission light to a reference detector arranged in the illumination device.

8. The transmission device according to claim 6, wherein the illumination device comprises a light mixer configured to homogenize the emission light generated by the emission source and to distribute the emission light with equal intensity onto the plurality of partial beam paths

9. The transmission device according to claim 8, wherein the light mixer having a rectangular cross-section.

10. The transmission device according to claim 8, wherein the plurality of partial beam paths in the illumination device each extend in an optical waveguide, an entry side of each optical waveguide adjoins the light mixer so as to be bundled together, the optical waveguides in which the transmission beam paths extend being configured to guide a portion of the emission light from the light mixer to a corresponding emission opening of the illumination device.

11. The transmission device according to claim 10, wherein the emission openings are formed as cut-outs in a holding plate.

12. The transmission device according to claim 10, further comprising a spherical lens arranged in each emission opening.

13. The transmission device according to claim 8, wherein the emission source comprises at least two light emitting diodes, emission light from the at least two light-emitting diodes being gathered in the light mixer, an interference filter being arranged between each of the at least two light-emitting diodes and the light mixer.

14. The transmission device according to claim 13, further comprising a first spherical lens arranged in front of each interference filter and a second spherical lens being arranged behind each interference filter.

15. The transmission device according to claim 13, wherein a wavelength of each of the at least two light-emitting diodes being selected from a group consisting of 405 nm, 450 nm, 540 nm and 630 nm.

16. A method for examining at least one sample in a microtiter plate by transmission of emission light generated during a first period of time in an illumination device from an emission source, the emission light being guided through at least one cavity of the microtiter plate in which the at least one sample is located, light signals received from the at least one cavity being measured by at least one detector arranged in a detection device during the first period of time, that the method comprising:
protecting the at least one detector from incident scattered light by an angle-dependent filter arranged between the illumination device and the at least one detector in a beam path of the emission light; and
substantially only letting through light beams of which an angle of incidence is smaller than a predetermined critical angle.

17. The method according to claim 16, further comprising:
measuring the light signals during the first period of time where emission light is guided through the at least one cavity;
measuring the light signals during a second period of time during a dark measurement where no emission light is guided through the at least one cavity; and
subtracting the light signals measured during the second period of time from the light signals measured during the first period of time.

18. The method according to claim 17, further comprising repeating the measuring steps and the subtracting step for each of a plurality of cycles.

19. The method according to claim 16, further comprising splitting the emission light up; guiding the split emission light through a plurality of cavities of the microtiter plate at a same time, and measuring the light signals of each cavity by a corresponding detector comprising the at least one detector.

20. The method according to claim 16, further comprising:
measuring one or more of an aging of the emission source and a change in an intensity of the emission light from the emission source using a reference measurement, the emission light being guided along a reference beam path to a reference detector arranged in the illumination device to detect the intensity of the emission light; and
comparing the intensity of the emission light with one or more of previously measured values and predefined values for the intensity of the emission light.
